(19) United States
(12) Patent Application Publication
(10) Pub. No.: US 2025/0140003 A1
(43) Pub. Date: May 1, 2025

(54) GENERATING IMAGE METADATA

(71) Applicant: Capital One Services, LLC, McLean, VA (US)

(72) Inventors: Sunilkumar KOTHI REDDY, Little Elm, TX (US); Ravi KALIDINDI, Mckinney, TX (US); Ainsly Joseph DSOUZA, Udupi Taluk (IN); Kshitij MATHUR, Bangalore (IN); Joydeep DASGUPTA, Bangalore (IN); Amrit Presanna KUMAR, Thalassery (IN); Harsimran BASRA, Bangalore (IN); Vishwajeet Shrikrishna LOHAKAREY, Bangalore (IN)

(21) Appl. No.: 18/497,681

(22) Filed: Oct. 30, 2023

(51) Int. Cl. G06V 20/70; G06T 3/40; G06T 7/00; G06T 11/60; G06V 10/60; H04N 5/272

(52) U.S. Cl. CPC G06V 20/70; G06T 3/40; G06T 7/0002; G06T 11/60; G06V 10/60; H04N 5/272; G06T 2207/30168; G06T 2207/30252; G06T 2207/30268

(57) ABSTRACT

In some implementations, a device for generating image metadata may obtain a plurality of images associated with a plurality of vehicles. The device may generate, for each image of the plurality of images, metadata associated with the image. The device may generate the metadata in accordance with a machine learning model and in accordance with one or more characteristics associated with the image. The metadata may indicate, for example, a size of the image, a view of a vehicle included in the image, an angle of the vehicle included in the image, a quality of the image, and/or a background of the image. The device may modify the image in accordance with the metadata.

### BACKGROUND

A web page may display one or more products and information associated with the one or more products. In one example, the web page may display images associated with a vehicle, describe one or more characteristics of the vehicle, and/or indicate a price for the vehicle. A user may visit the web page to view the vehicle information and to determine whether the user is interested in purchasing the vehicle. In some cases, a host for the web page may receive vehicle information from multiple different sources, such as multiple different vehicle dealerships, and may display the information received from the multiple different vehicle dealerships to a user that visits the web page.

### SUMMARY

Some implementations described herein relate to a system for generating image metadata. The system may include one or more memories and one or more processors communicatively coupled to the one or more memories. The one or more processors may be configured to obtain a plurality of images associated with a plurality of vehicles. The one or more processors may be configured to generate, for each image of the plurality of images, metadata associated with the image, wherein the one or more processors, to generate the metadata associated with the image, are configured to generate the metadata in accordance with a machine learning model and in accordance with one or more characteristics associated with the image. The one or more processors may be configured to modify the image in accordance with the metadata.

Some implementations described herein relate to a method of generating image metadata. The method may include obtaining a plurality of images. The method may include generating, for each image of the plurality of images, metadata associated with the image, wherein generating the metadata associated with the image comprises generating the metadata in accordance with a machine learning model and in accordance with one or more characteristics associated with the image. The method may include modifying the image in accordance with the metadata.

Some implementations described herein relate to a non-transitory computer-readable medium that stores a set of instructions. The set of instructions, when executed by one or more processors of a device, may cause the device to obtain a plurality of images associated with a plurality of vehicles. The set of instructions, when executed by one or more processors of the device, may cause the device to generate, for each image of the plurality of images, metadata associated with the image, wherein the one or more instructions, that cause the device to generate the metadata associated with the image, cause the device to generate the metadata in accordance with a machine learning model and in accordance with one or more characteristics associated with the image.

### BRIEF DESCRIPTION OF THE DRAWINGS

FIGS. 1A-1B are diagrams of an example associated with generating image metadata, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with generating image metadata, in accordance with some embodiments of the present disclosure.

FIG. 4 is a flowchart of an example process associated with generating image metadata, in accordance with some embodiments of the present disclosure.

### DETAILED DESCRIPTION

The following detailed description of example implementations refers to the accompanying drawings. The same reference numbers in different drawings may identify the same or similar elements.

The vehicle buying journey has evolved significantly in recent years, now including many digital aspects that have transformed the way that people research, select, and enter into vehicle transactions. Starting from initial exploration to a final transaction, digital tools and platforms may play an important role in enhancing the vehicle buying experience. For example, prospective buyers can utilize various online resources, such as manufacturer websites, online marketplaces, and automotive review websites, to gather information about different vehicle models, specifications, features, pricing, and/or customer reviews, which allows prospective buyers to compare options and make informed choices. In addition, many vehicle dealerships and/or manufacturers offer virtual tours that enable potential buyers to explore the interior and/or exterior of a vehicle without having to physically visit a vehicle dealership.

A web page, such as a web page that is hosted by a vehicle financing entity, may display vehicle information that includes vehicle images, vehicle characteristics (such as vehicle performance, fuel efficiency, cargo space, and legroom, among other examples) and/or vehicle pricing. A user may visit the web page to view the vehicle information and to determine whether the user is interested in purchasing the vehicle. The vehicle financing entity may receive vehicle information from multiple different sources, such as multiple different vehicle dealerships, and may display the vehicle information received from the multiple different vehicle dealerships. In one example, the vehicle financing entity may receive a first set of vehicle images from a first vehicle dealership and may receive a second set of vehicle images from a second vehicle dealership, the first set of vehicle images being associated with a first vehicle and the second set of vehicle images being associated with a second vehicle. However, the vehicle financing entity may not receive metadata associated with the first set of vehicle images or the second set of vehicle images. This may result in the vehicle images being displayed on the web page in an inconsistent manner. For example, the first vehicle may be displayed from a front-angle of the vehicle, may be blurry, and/or may have a small image size, while the second vehicle may be displayed from a passenger-side-angle of the vehicle, may have a distracting background, and/or may have a large image size. However, since the vehicle images are received from the vehicle dealerships without accompanying metadata, it may be difficult for the vehicle financing entity to sort the images. This may result in a poor customer experience and/or may require the vehicle financing entity to manually generate metadata for the images, which may be time consuming and may require a large number of processing resources. Additionally, this may result in the vehicle financing entity receiving and storing a large number of vehicle images, which may be a waste of storage resources since only some of those image may have high enough quality to be displayed on the web page.

Some implementations described herein relate to generating image metadata. In some implementations, a system may obtain a plurality of images associated with a plurality of vehicles. For example, the system, which may be associated with a vehicle financing entity, may receive a first set of vehicle images from a first vehicle dealership and may receive a second set of vehicle images from a second vehicle dealership, the first set of vehicle images being associated with a first vehicle and the second set of vehicle images being associated with a second vehicle. The system may generate metadata for each image of the plurality of images. In some implementations, the system may generate the metadata for the images in accordance with a machine learning model and in accordance with one or more characteristics associated with the image. In an example that the first set of images includes three images associated with the first vehicle and the second set of images includes four images associated with the second vehicle, the system may generate metadata for each of the three images associated with the first vehicle and each of the four images associated with the second vehicle. For example, the system may generate metadata that indicates a size of the image, a quality of the image, an angle of the vehicle included in the image, and a background of the image, among other examples. In some implementations, the system may modify one or more of the images in accordance with the metadata. For example, the system may resize one or more of the images to a standard image size, delete one or more of the images in accordance with the images not having a quality that satisfies a quality threshold, arrange the images in accordance with the angle of the vehicle included in the image (e.g., such that a primary image for each vehicle is from a same angle) and/or may remove or change a background of the image. This may improve a customer experience, for example, by enabling the customer to view all vehicles from a same angle and by not displaying images having a poor quality or a distracting background. Additionally, this may reduce an amount of system storage resources required for storing the vehicle images by only storing images that satisfy certain quality characteristics. Even further, this may reduce an amount of network resources by only loading the images that satisfy the certain quality characteristics. These example advantages, among others, are described in more detail below.

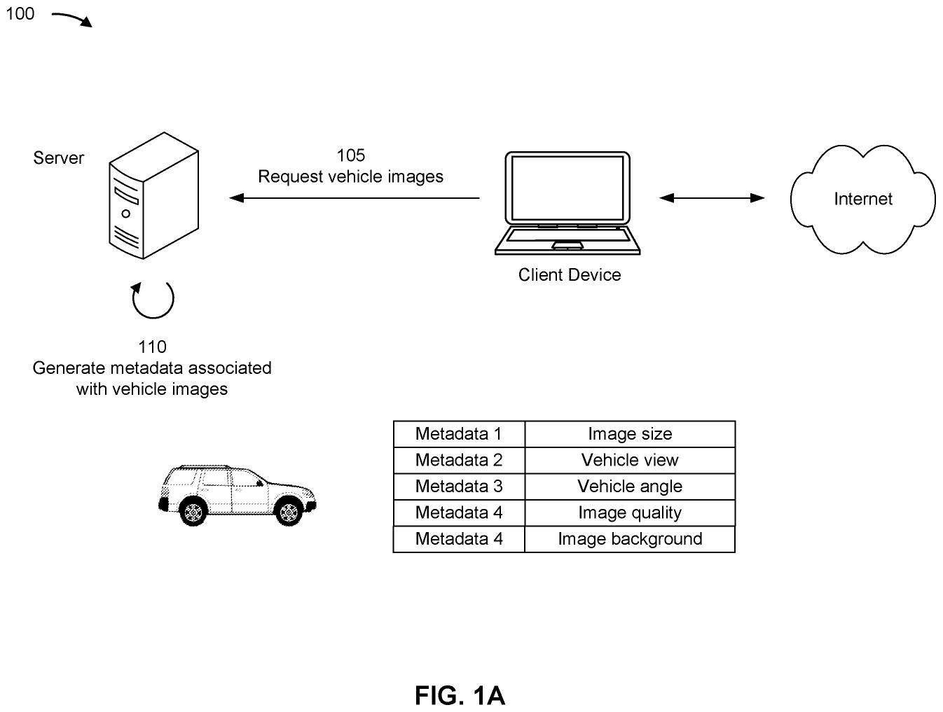

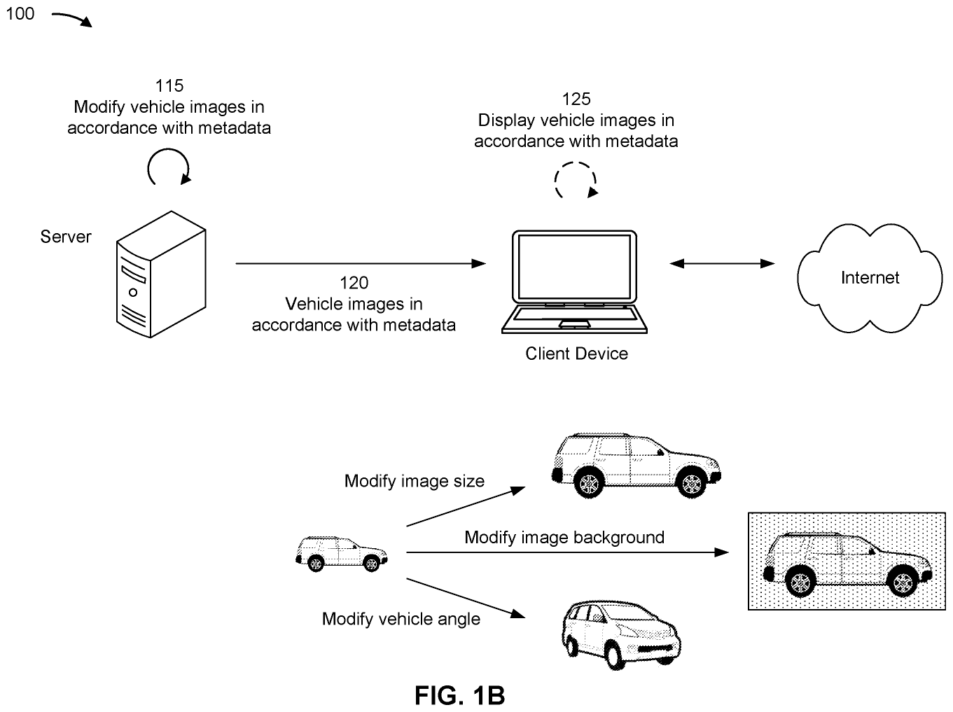

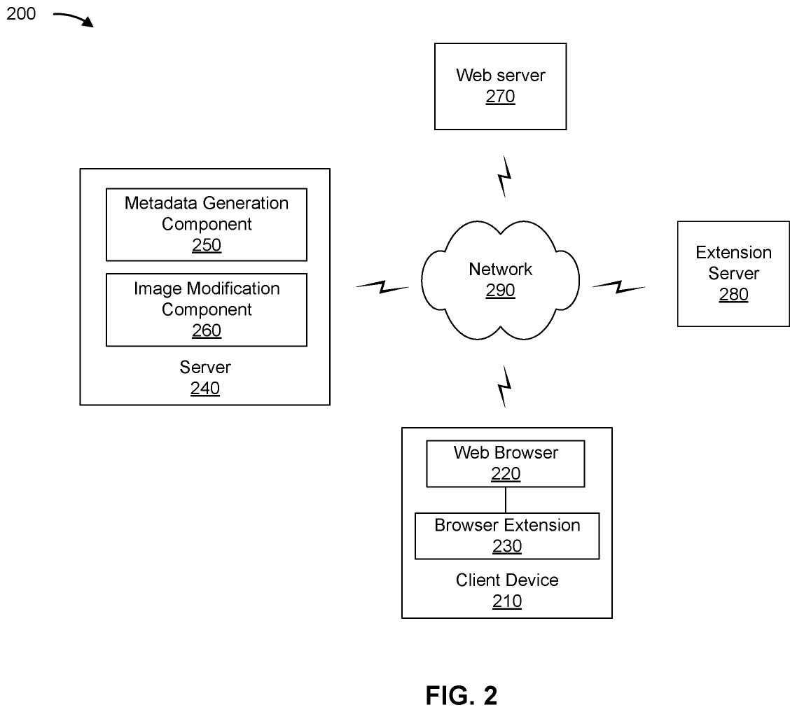

FIGS. 1A-1B are diagrams of an example 100 associated with generating image metadata. As shown in FIGS. 1A-1B, example 100 includes a client device and server. The client device and the server may communicate via the Internet. Additional details associated with the client device and the server are described in connection with FIG. 2.

As shown in FIG. 1A, and by reference number 105, the client device may request one or more images. For example, the client device may visit a web page that is hosted by the server, and the server may provide the one or more images to the client device based on the client device visiting the web page. In some examples, the server may be associated with a vehicle financing entity. A user of the client device may enter a web address of a web page that is hosted by the server, and/or may enter information associated with one or more vehicles, and the server may provide one or more vehicle images (and/or other vehicle information) to the client device based on the client device visiting the web page and/or entering the information associated with the one or more vehicles.

As shown by reference number 110, the server may generate metadata associated with one or more images. As described above, the server (e.g., a device associated with the vehicle financing entity) may receive a plurality of images associated with a plurality of vehicles. However, at least a portion of the plurality of images associated with the plurality of vehicles may not include metadata. For example, the server may receive the plurality of images associated with the plurality of vehicles from a plurality of sources, such as sources associated with different vehicle dealerships, and the plurality of images may have different characteristics, such as different images sizes, image qualities, vehicle views, vehicle angles, and image backgrounds, among other examples. The server may be configured to generate metadata for the plurality of images. For example, the server may generate the metadata for the plurality of images using a machine learning model and in accordance with one or more characteristics of the images. In some implementations, the server may generate metadata that indicates at least one of the image size, the vehicle view, the vehicle angle, the image quality, or the image background, among other examples. The metadata that indicates the image size may indicate an exact size (e.g., in bytes or megabytes) for the image and/or may classify the image into a select size of a plurality of sizes, such as extra-small, small, medium, large, and extra-large, among other examples. The metadata that indicates the vehicle view may classify the image as being associated with a select vehicle view of a plurality of vehicle views, such as a view of the exterior of the vehicle, a view of an exterior component of the vehicle (e.g., a headlight), a view of an interior the vehicle, a view of an interior component of the vehicle (e.g., a dashboard), or a poster view of the vehicle, among other examples. The metadata that indicates the vehicle angle may classify the image as being associated with a vehicle angle of a plurality of vehicle angles, such as a front-angle, a back-angle, a driver-side-angle, a passenger-side-angle, a front-left-angle, a front-right-angle, a back-left-angle, a back-right-angle, or a top-down angle, among other examples. In some implementations, the vehicle angle may include interior angles, such as a driver-seat-angle, a dashboard-angle, and a rear-seat-angle, among other examples. The metadata that indicates the image quality may classify the image quality as acceptable or not acceptable, and/or may classify the image quality into a select image quality of a plurality of image qualities, such as low quality, medium quality, or high quality, among other examples. In some implementations, the image quality may indicate a blur characteristic, a shadow characteristic, an overlapping external object characteristic, or a lighting characteristic, among other examples. The metadata that indicates the image background may indicate a type of background included in the image, such as whether the background is a plain color (e.g., a white background) or is a background that includes objects other than the vehicle. In some implementations, the server may generate other types of metadata for the vehicle images, and/or may generate metadata for other types of images that do not include vehicles.

As shown in FIG. 1B, and by reference number 115, the server may modify the vehicle images in accordance with the metadata. In some implementations, the server may modify the images in accordance with the image size, the vehicle view, the vehicle angle, the image quality, and/or the image background, among other examples. The server may modify an image in accordance with the image size, for example, by reducing a size of the image or enlarging a size of the image to a standard image size. Additionally, or alternatively, the server may discard one or more images that do not conform to the standard image size. The server may modify the image in accordance with the vehicle view, for example, by organizing the images in accordance with the vehicle view. The server may display all images on a primary web page from a particular vehicle view, such as an exterior view of the vehicle. Thus, modifying the images may include changing a primary vehicle image from a first vehicle image to a second vehicle image in accordance with the vehicle view. In some examples, the server may delete certain images in accordance with the images being duplicates (e.g., three of the same images of the same vehicle having the same view) or may delete all images associated with a vehicle in accordance with the images not including a particular vehicle view. The server may modify the image in accordance with the vehicle angle, for example, by organizing the images in accordance with the vehicle angle. The server may display all images on a primary web page from a particular vehicle angle, such as a front-left-angle of the vehicle. Thus, modifying the images may include changing a primary vehicle image from a first vehicle image to a second vehicle image in accordance with the vehicle angle. In some examples, the server may delete certain images in accordance with the images being duplicates (e.g., two of the same images of the same vehicle having the same angle) or may delete all images associated with a vehicle in accordance with the images not including a front-left-angle of the vehicle. The server may modify the images in accordance with the image quality, for example, by deleting images that do not satisfy a quality threshold, and/or by prioritizing images that have a higher quality over images that have a lower quality. The server may modify the images in accordance with the image background, for example, by changing all images backgrounds to a standard image background (e.g., a white background or a gray background), deleting images having a background that is distracting, and/or prioritizing images having a plain background over images having a background that is distracting. In some examples, the server may modify the images based on one or more characteristics of the client device. For example, the server may modify the images to have a larger size or a higher quality threshold in accordance with the client device being a laptop, or may modify the images to have a smaller size or a lower quality threshold in accordance with the client device being a cellular telephone.

As shown by reference number 120, the server may provide the images to the client device in accordance with the image metadata. For example, the server may provide the images to the client device in accordance with the images being modified based on the metadata. In some implementations, the server may cause the client device to display one or more vehicle images having one or more characteristics. For example, the server may cause the client device to display a web page that includes, for each vehicle of a plurality of vehicles, a primary image, one or more vehicle characteristics (such as vehicle performance, fuel efficiency, cargo space, and legroom, among other examples) and/or vehicle pricing. The primary image may be an image that has one or more image characteristics, as indicated by the metadata. In some implementations, the server may cause the client device to display an image, based on the metadata associated with the image, having a standard image size (e.g., medium), a certain vehicle view (e.g., an exterior view), a certain vehicle angle (e.g., a front-left-angle of the vehicle), a certain image quality (e.g., an image quality that is above an image quality threshold), and with a certain image background (e.g., a white background). Thus, the web page may display a plurality of vehicles (based on one or more parameters provided by the user), and may display, for each vehicle of the plurality of vehicles, a primary image for the vehicle having metadata that meets one or more of the characteristics. Additionally, the web page may enable the client device to select a vehicle (e.g., to click on the vehicle) to view one or more other images associated with the vehicle. The one or more other images may be organized in accordance with the metadata. For example, each vehicle may have a second image that shows a driver-side angle of the vehicle, and may have a third image that shows an interior view of the vehicle.

As shown by reference number 125, the client device may display the images via the web page. For example, the client device may display the vehicle images in accordance with the metadata. A user of the client device may be able to view the vehicle images and the one or more vehicle characteristics, and may be able to browse other information associated with the vehicle, such as vehicle financing information. This may improve the user experience since all vehicles may be displayed from a same view and a same angle, and may only be displayed in accordance with the vehicle images having a certain quality, size, and/or background, which may improve the user's ability to compare the vehicles displayed on the web page. Rather than a primary image of a first vehicle being a passenger-view of the vehicle and having a distracting background, and a primary image of a second vehicle being an interior view of the vehicle and being blurry, which may make it difficult for the user to compare the vehicles, the user may be able to view all images (for a plurality of vehicles) having a same view, angle, size, quality, and background, which may make it easy for the user to compare the vehicles.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a client device 210 (e.g., which may execute a web browser 220 and a browser extension 230), a server 240 (e.g., which may include a metadata generation component 250 and an image modification component 260), a web server 270, an extension server 280, and a network 290. The client device 210 may correspond to the client device described in connection with FIGS. 1A-1B. For example, the client device 210 may be configured to request vehicle images from the server 240 and to display the vehicle images to a user of the client device 210. The server 240 may correspond to the server described in connection with FIGS. 1A-1B. For example, the server 240 may be configured to generate metadata for vehicle images and/or to modify the vehicle images in accordance with the metadata. Devices of environment 200 may interconnect via wired connections, wireless connections, or a combination of wired and wireless connections.

The client device 210 may include a device that supports web browsing. For example, the client device 210 may include a computer (e.g., a desktop computer, a laptop computer, a tablet computer, and/or a handheld computer), a mobile phone (e.g., a smart phone), a television (e.g., a smart television), an interactive display screen, and/or a similar type of device. The client device 210 may host a web browser 220 and/or a browser extension 230 installed on and/or executing on the client device 210.

The web browser 220 may include an application, executing on the client device 210, that supports web browsing. For example, the web browser 220 may be used to access information on the World Wide Web, such as web pages, images, videos, and/or other web resources. The web browser 220 may access such web resources using a uniform resource identifier (URI), such as a uniform resource locator (URL) and/or a uniform resource name (URN). The web browser 220 may enable the client device 210 to retrieve and present, for display, content of a web page. In some implementations, the web browser 220 may be used to access information, such as web pages, images, video, and/or other web resources, that are hosted or otherwise made available by the server 240.

The browser extension 230 may include an application, executing on the client device 210, capable of extending or enhancing functionality of the web browser 220. For example, the browser extension 230 may be a plug-in application for the web browser 220. The browser extension 230 may be capable of executing one or more scripts (e.g., code, which may be written in a scripting language, such as JavaScript) to perform an operation in association with the web browser 220.

The server 240 may include a device that is capable of generating image metadata and/or modifying images in accordance with image metadata. Additionally, the server 240 may include a device that is capable of providing the images and/or the image metadata to the client device 110. In some implementations, the web server 270 and the extension server 280 may be included in the server 240. In some other implementations, the web server 270 and the extension server 280 may be separate from the server 240. The metadata generation component 250 may generate metadata associated with one or more images, such as one or more vehicle images. For example, the metadata generation component 250 may generate metadata that indicates an image size, a vehicle view, a vehicle angle, an image quality, and/or an image background. The image modification component 260 may modify one or more of the vehicle images in accordance with the metadata. For example, the image modification component 260 may adjust a size of the image, organize or delete images having certain vehicle views, vehicle angles, or vehicles qualities, and/or change a background of an image. Additional details regarding these features are described above in connection with FIGS. 1A-1B.

The web server 270 may include a device capable of serving web content (e.g., web documents, HTML documents, web resources, images, style sheets, scripts, and/or text). For example, the web server 270 may include a server and/or computing resources of a server, which may be included in a data center and/or a cloud computing environment. The web server 270 may process incoming network requests (e.g., from the client device 210) using HTTP and/or another protocol. The web server 270 may store, process, and/or deliver web pages to the client device 210. In some implementations, communication between the web server 270 and the client device 210 may take place using HTTP. In some implementations, the web server 270 may include a device capable of serving images (e.g., vehicle images) from the server 240 to the client device 210.

The extension server 280 may include a device capable of communicating with the client device 210 to support operations of the browser extension 230. For example, the extension server 280 may store and/or process information for use by the browser extension 230. As an example, the extension server 280 may store a list of domains applicable to a script to be executed by the browser extension 230. In some implementations, the client device 210 may obtain the list (e.g., periodically and/or based on a trigger), and may store a cached list locally on the client device 210 for use by the browser extension 230.

The network 290 may include one or more wired and/or wireless networks. For example, the network 290 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

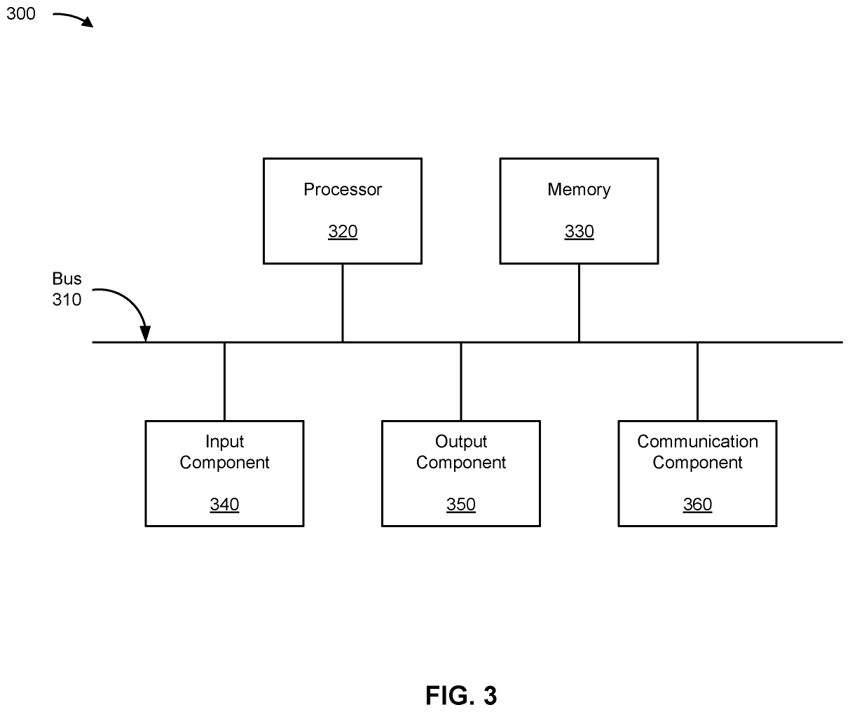

FIG. 3 is a diagram of example components of a device 300 associated with generating image metadata. The device 300 may correspond, for example, to the server 240. In some implementations, the server 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

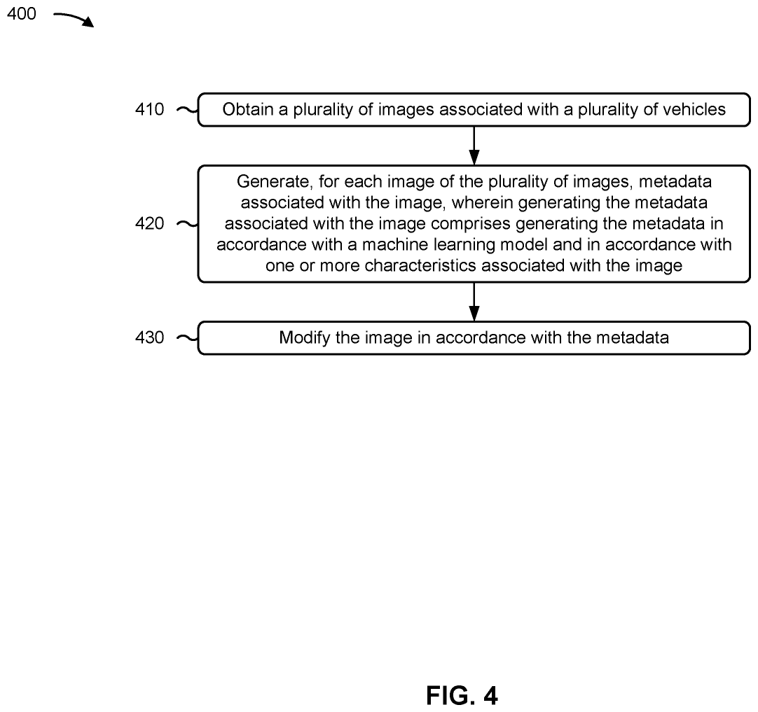

FIG. 4 is a flowchart of an example process 400 associated with generating image metadata. In some implementations, one or more process blocks of FIG. 4 may be performed by the server 240. In some implementations, one or more process blocks of FIG. 4 may be performed by another device or a group of devices separate from or including the server 240, such as the metadata generation component 250 and/or the image modification component 260. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a plurality of images associated with a plurality of vehicles (block 410). For example, the server 240 (e.g., using processor 320 and/or memory 330) may obtain a plurality of images associated with a plurality of vehicles. As an example, the server 240 may obtain (e.g., receive) receive a first set of vehicle images from a first vehicle dealership and may receive a second set of vehicle images from a second vehicle dealership, the first set of vehicle images being associated with a first vehicle and the second set of vehicle images being associated with a second vehicle. In some examples, the first set of vehicle images and the second set of vehicle images may not be accompanied by image metadata.

As further shown in FIG. 4, process 400 may include generating, for each image of the plurality of images, metadata associated with the image (block 420). For example, the server 240 (e.g., using processor 320 and/or memory 330) may generate, for each image of the plurality of images, metadata associated with the image, as described above in connection with reference number 110 of FIGS. 1A-1B. In some implementations, the one or more processors, to generate the metadata associated with the image, are configured to generate the metadata in accordance with a machine learning model and in accordance with one or more characteristics associated with the image. As an example, the server 240 may generate metadata for each image included in the first set of images and for each images included in the second set of images, where the metadata indicates, for example, an image size, a vehicle view, a vehicle angle, an image quality, and/or an image background.

As further shown in FIG. 4, process 400 may include modifying the image in accordance with the metadata (block 430). For example, the server 240 (e.g., using processor 320 and/or memory 330) may modify the image in accordance with the metadata, as described above in connection with reference number 115 of FIGS. 1A-1B. As an example, the server 240 may modify a size of the images, may organize or delete images in accordance with a vehicle view, may organize or delete images in accordance with a vehicle angle, may modify or delete images in accordance with a vehicle quality, and/or may modify an image background, among other examples.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating image metadata, the system comprising:
one or more memories; and
one or more processors, communicatively coupled to the one or more memories, configured to:
obtain a plurality of images associated with a plurality of vehicles;
generate, for each image of the plurality of images, metadata associated with the image,
wherein the one or more processors, to generate the metadata associated with the image, are configured to generate the metadata in accordance with a machine learning model and in accordance with one or more characteristics associated with the image; and
modify the image in accordance with the metadata.

2. The system of claim 1, wherein the one or more processors, to generate the metadata associated with the image, are configured to generate metadata that indicates a quality of the image, wherein the quality of the image corresponds to at least one of a blur characteristic, a shadow characteristic, a lighting characteristic, or an external object characteristic.

3. The system of claim 1, wherein the one or more processors, to generate the metadata associated with the image, are configured to generate metadata that indicates a view of a vehicle included in the image, wherein the view of the vehicle corresponds to an exterior view of the vehicle, a view of an exterior component of the vehicle, an interior view of the vehicle, a view of an interior component of the vehicle, or a poster view of the vehicle.

4. The system of claim 1, wherein the one or more processors, to generate the metadata associated with the image, are configured to generate metadata that indicates an angle of a vehicle included in the image, wherein the angle of the vehicle corresponds to a select angle of a plurality of configured vehicle angles.

5. The system of claim 1, wherein the one or more processors, to modify the image, are configured to modify a size of the image or to modify a background of the image.

6. The system of claim 5, wherein the one or more processors, to modify the size of the image, are configured to modify the size of the image in accordance with a standard image size, and wherein the one or more processors, to modify the background of the image, are configured to remove the background of the image or to add a new background to the image.

7. The system of claim 1, wherein the one or more processors, to modify the image, are configured to select an image of the plurality of images, associated with a vehicle of the plurality of vehicles, that displays the vehicle in accordance with a configured vehicle angle.

8. The system of claim 1, wherein the one or more processors are further configured to identify an image having an image quality that does not satisfy an image quality threshold.

9. The system of claim 1, wherein the one or more processors, to obtain the plurality of images, are configured to receive the plurality of images without receiving any metadata associated with the plurality of images.

10. A method of generating image metadata, comprising:
obtaining a plurality of images;
generating, for each image of the plurality of images, metadata associated with the image,
wherein generating the metadata associated with the image comprises generating the metadata in accordance with a machine learning model and in accordance with one or more characteristics associated with the image; and
modifying the image in accordance with the metadata.

11. The method of claim 10, wherein generating the metadata associated with the image comprises generating metadata that indicates a quality of the image, wherein the quality of the image corresponds to at least one of a blur characteristic, a shadow characteristic, a lighting characteristic, or an external object characteristic.

12. The method of claim 10, wherein generating the metadata associated with the image comprises generating metadata that indicates a view of an object included in the image, wherein the view of the object corresponds to an exterior view of the object, a view of an exterior component of the object, an interior view of the object, a view of an interior component of the object, or a poster view of the object.

13. The method of claim 10, wherein generating the metadata associated with the image comprises generating metadata that indicates an angle of an object included in the image, wherein the angle of the object corresponds to a select angle of a plurality of configured object angles.

14. The method of claim 10, wherein modifying the image comprises at least one of modifying a size of the image or modifying a background of the image.

15. The method of claim 10, wherein modifying the image comprises selecting an image of the plurality of images, associated with an object of a plurality of objects, that displays the object in accordance with a configured object angle.

16. A non-transitory computer-readable medium storing a set of instructions, the set of instructions comprising:
one or more instructions that, when executed by one or more processors of a device, cause the device to:
obtain a plurality of images associated with a plurality of vehicles; and
generate, for each image of the plurality of images, metadata associated with the image,
wherein the one or more instructions, that cause the device to generate the metadata associated with the image, cause the device to generate the metadata in accordance with a machine learning model and in accordance with one or more characteristics associated with the image.

17. The non-transitory computer-readable medium of claim 16, wherein the one or more instructions, that cause the device to generate the metadata associated with the image, cause the device to generate metadata that indicates a quality of the image, wherein the quality of the image corresponds to at least one of a blur characteristic, a shadow characteristic, a lighting characteristic, or an external object characteristic.

18. The non-transitory computer-readable medium of claim 16, wherein the one or more instructions, that cause the device to generate the metadata associated with the image, cause the device to generate metadata that indicates a view of a vehicle of the plurality of vehicles, wherein the view of the vehicle corresponds to an exterior view of the vehicle, a view of an exterior component of the vehicle, an interior view of the vehicle, a view of an interior component of the vehicle, or a poster view of the vehicle.

19. The non-transitory computer-readable medium of claim 16, wherein the one or more instructions, that cause the device to generate the metadata associated with the image, cause the device to generate metadata that indicates an angle of a vehicle of the plurality of vehicles, wherein the angle of the vehicle corresponds to a select angle of a plurality of configured vehicle angles.

20. The non-transitory computer-readable medium of claim 16, wherein the one or more instructions, when executed by the one or more processors, further cause the device to modify the image in accordance with the metadata.
